(19) United States
(12) Patent Application Publication
(10) Pub. No.: US 2006/0014904 A1
(43) Pub. Date: Jan. 19, 2006

(54) Polymer compositions and method for producing a molded body

(75) Inventors: Masahiko Oka, Osaka (JP); Katsuyoshi Kubo, Orangeburg, NY (US); Tsuyoshi Miyamori, Osaka (JP); Yoshiki Maruya, Osaka (JP); Megumi Satou, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka (JP)

(21) Appl. No.: 11/160,863

(22) Filed: Jul. 13, 2005

Related U.S. Application Data
(60) Provisional application No. 60/587,059, filed on Jul. 13, 2004.

(51) Int. Cl. C08L 27/12

(52) U.S. Cl. 525/199

(57) ABSTRACT

A polymer composition of matter is disclosed which includes a thermoplastic polymer and a fluorine-containing polymer. The thermoplastic polymer is an amorphous non-fluorinated thermoplastic polymer or a crystalline non-fluorinated thermoplastic polymer with a melting point of 180° C. or higher. The fluorine-containing polymer has a zero shear viscosity at 340° C. of 0.2 Pa.s or greater and less than 5000 Pa.s, and is present to the extent of 0.005-2 mass % of the total of the thermoplastic polymer and the fluorine-containing polymer.

### BACKGROUND OF THE INVENTION

1. Field of the Invention

The present invention relates to polymer compositions of matter and methods for producing a molded body.

2. Background Information

Processable polymers are usually molded by heating to a molten state within a molding unit, the melt obtained is introduced into a mold or the like to be molded, and is then cooled. Examples of molding methods are extrusion molding and injection molding and the like. Extrusion molding involves the molten material being transported by a screw to a die for molding, while injection molding involves the molten material being injected into a mold.

In comparing extrusion molding between polymers that have the same melt flowability, the extrusion pressure and the extrusion torque will usually be high in polymers that have a strong affinity for the metal of the screw, cylinder, die, and the like in the extruder, where frictional forces will be large. The extrusion pressure or the extrusion torque becoming too large will generate industrial production problems, such as the extrusion unit being automatically shut down due to the overload from exceeding its limits. Moreover, with injection molding, the polymer temperature will become high due to shear heating with the shot end unit, the nozzle, the runner of the mold, and the gate, and a longer time will be required for cooling the interior of the mold, which damages industrial productivity.

Moreover, when unanticipated fluctuations arise from irregular pressure and torque while the polymer is molten inside the mold, the smoothness and gloss of the surface of the molded body obtained will be inferior, and there will wide variations in the density and dimensions of the molded article. Either difficulty in providing products of a stable quality, or a potential for decreased yields and productivity, will be problems during manufacturing.

Thus, in order to improve the molding processability, the method of adding processing aids primarily to polypropylene and polyethylene and the like has been tried. It is known that the use of low concentrations of a fluorine-containing polymer as a processing aid of this type is helpful in diminishing the effect of melt fracture or high torque on limiting the extrusion rate, primarily for polypropylene and polyethylene and the like (see, for example, WO 94/05712 and WO 00/69967).

Thus, in response to the growing demand for non-fluorinated thermoplastic polymers (such as polyethylene terephthalate, polyamides, and the like) with a melting point higher than polypropylene and polyethylene (180° C. or greater) and amorphous non-fluorinated thermoplastic polymers for use as molding materials, investigations have been carried out recently concerning which high melting point polymers would be particularly effective processing aids, and various suggestions have been made (see, for example, WO 00/69972, US Patent Application Publication 2003-01 09646, US Patent Application Publication 2004-0102572, and WO 03/44088).

However, the specific requirements in terms of mold processability have not been satisfied, and further improvements are desirable.

Taking account of the above situation, an object of the present invention is to provide a polymer composition which has increased mold processability, in order to prevent the pressure inside the cylinder for melting and the torque for rotating the screw from becoming high during the mold processing of amorphous non-fluorinated thermoplastic polymers or crystalline non-fluorinated thermoplastic polymers with a melting point of 180° C. or higher. This invention addresses this object as well as other objects, which will become apparent to those skilled in the art from this disclosure.

### SUMMARY OF THE INVENTION

The present inventors remarkably observed that when the molecular weight of a fluorine-containing polymer was low, the viscosity of the fluorine-containing polymer during mold processing was reduced, and that it was possible to obtain a relative increase in the mold processability of a crystalline non-fluorinated thermoplastic polymer with a melting point of 180° C. or higher or of an amorphous non-fluorinated thermoplastic polymer (referred to below as the “host polymers”), and they arrived at the conception of the present invention below.

The present invention is a polymer composition of matter comprising the abovementioned thermoplastic polymer, which can be an amorphous non-fluorinated thermoplastic polymer or a crystalline non-fluorinated thermoplastic polymer with a melting point of 180° C. or higher, and the abovementioned fluorine-containing polymer that will have a zero shear viscosity at 340° C. of 0.2 Pa.s or greater and less than 5000 Pa.s, with the fluorine-containing polymer being present to the extent of 0.005-2 mass % of the total of the abovementioned thermoplastic polymer and the abovementioned fluorine-containing polymer.

The present invention is also a method for producing a molded part, wherein the molded part is produced by molding a melt of the abovementioned polymer composition.

The polymer composition of matter of the present invention comprises a host polymer and a fluorine-containing polymer.

The abovementioned fluorine-containing polymer is a polymer with fluorine atoms bonded to a main chain constructed entirely or partly of carbon atoms. Examples of this type of fluorine-containing polymer, in terms of the monomers, include polymers obtained by polymerization using one or two or more types of perfluoromonomer.

When the abovementioned fluorine-containing polymers are partially crystalline, they will have a melting point.

The abovementioned perfluoromonomers are monomers constructed of a main chain of carbon atoms and fluorine atoms, and may also include oxygen atoms, with no hydrogen atoms bonded to the carbon atoms of the main chain, the perfluoromonomers including tetrafluoroethylene [TFE] and hexafluoropropylene (HFP), as well as perfluoro(alkyl vinyl ether) [PAVE] monomers such as perfluoro(propyl vinyl ether) [PPVE]. The abovementioned oxygen atoms are generally ether oxygens.

The abovementioned fluorine-containing polymers will have a zero shear viscosity at 340° C. of 0.2 Pa.s or greater and less than 5000 Pa.s.

When the polymer composition of matter of the present invention is blended with a fluorine-containing polymer having a zero shear viscosity at 340° C. within the abovementioned range, increases in the extrusion pressure and extrusion torque during mixing and mold processing are suppressed, and the mold processability is increased. For the abovementioned zero shear viscosity at 340° C., the preferred lower limit is 1 Pa.s and the more preferred lower limit is 2 Pa.s, and the preferred upper limit is 4000 Pa.s and the more preferred upper limit is 3200 Pa.s.

The zero shear viscosity is fixed so that the angular frequency will be in the region of 1 rad/second or less. For example, the zero shear viscosity can be obtained by extrapolating the actual value of the viscosity to the point of zero shear stress (reference document: “Easy Rheology”, p. 77, by Kenkichi Murakami, Sangyo Tosho Publishing).

To be more precise, in the present specification, the abovementioned “zero shear viscosity at 340° C.” is the value obtained from the actual value measured for the melt viscosity.

A description of the method for obtaining the zero shear viscosity at 340° C. from the actual value measured for the melt viscosity is shown below in (1) and (2).

(1) The measured melt viscosity of a fluorine-containing polymer, if it is possible to observe an actual value at 340° C., is obtained from this actual value by fixing the angular frequency in the region of 1 rad/second or less at 340° C., or is the viscosity obtained by extrapolating to the point of zero shear stress from the actual value in the region of 1 rad/second or more.

(2) In the measured melt viscosity for a fluorine-containing polymer, if it is not possible to observe an actual value at 340° C., it can be calculated from the conversion formula as shown below.

In other words, having an almost identical monomer composition ratio to the fluorine-containing polymer [P₀] for which a calculation of the zero shear viscosity at 340° C. is desired, a fluorine-containing polymer [P₁] prepared with a higher molecular weight is used. From the temperature T₁ for the zero shear viscosity η₀ (P₁, T₁), a conversion factor α is obtained from the zero shear viscosity at 340° C., η₀ (P₁, 340). Furthermore, for a temperature T₁ in the range of the melting point for the fluorine-containing polymer [P₀] or higher but less than 340° C., the zero shear viscosity of the fluorine-containing polymer [P₀] can be extrapolated from the actual value at any desired temperature.

More precisely, the zero shear viscosity η₀(P₁, 340) at 340° C., and the zero shear viscosity η₀(P₁, T₁) at temperature T₁ are obtained by extrapolation from the actual values at each temperature, with the conversion constant α calculated from formula (1) below, and are obtained from the conversion formula (2) indicated below.
α=η₀(P₁, 340)/η₀(P₁, T₁) (1)
η₀(P₀, 340)=α×η₀(P₀, T₁) (2)

Thus, for the fluorine-containing polymer [P₀], the zero shear viscosity η₀(P₀, T₁) at the abovementioned temperature T₁ is obtained by extrapolation from the actual values, and the zero shear viscosity η₀(P₀, 340) at 340° C. is obtained by calculation from the conversion formula (2).

For example, in the case when the fluorine-containing polymer is FEP, for the fluorine-containing polymer [PFEP₀] used in the polymer composition of the present invention, an actual value for the melt viscosity usually cannot be obtained at 340° C. With the zero shear viscosity η₀(FEP₁, 340) (units of poise; the same below) at 340° C. extrapolated from the actual value for the well known FEP [PFEP₁] at 340° C., the η₀(FEP₁, 285) is extrapolated from the actual value at 285° C. (corresponding to the abovementioned T₁) so that from the formula below:
αFEP₁=η₀(FEP₁, 340)/η₀(FEP₁, 285)
a value of 0.701 is calculated for the conversion factor αFEP₁, and the conversion formula below is obtained:
η₀(FEP₀, 340)=0.701×η₀(FEP₀, 285)

Using the above conversion formula for the fluorine-containing polymer [PFEP₀], the zero shear viscosity at 285° C. η₀(FEP₀, 285) is obtained by extrapolation from the actual values, and the zero shear viscosity at 340° C. η₀(FEP₀, 340) is calculated. For the abovementioned well-known FEP [PFEP₁], an FEP with a weight average molecular weight of 300,000 or higher is preferable.

In addition, it is preferable for the fluorine-containing polymer of the present invention to have a weight average molecular weight [M_{w}]of 10,000˜300,000. Generic FEP is normally used as a molding material, and the use of FEP with a weight average molecular weight [M_{w}] of 300,000˜1,000,000 as a processing aid was known heretofore. However, the abovementioned fluorine-containing polymer used in the present invention has a significantly lower molecular weight than the fluoropolymer generally used having a weight average molecular weight [M_{w}] in the abovementioned range. For the weight average molecular weight [M_{w}] of the abovementioned fluorine-containing polymer, a lower limit of 15,000 is more preferable and a lower limit of 30,000 is furthermore preferable, and an upper limit of 250,000 is more preferable and a upper limit of 200,000 is furthermore preferable, and especially preferable is a lower limit of 125,000.

For example, in the case of FEP, the weight average molecular weight [M_{w}] for the fluorine-containing polymer can be estimated from the abovementioned “zero shear viscosity at 340° C.”. The zero shear viscosity at 340° C. [η₀: poise] and the weight average molecular weight [M_{w}] can be correlated with the formula (3) found below (quoted from Macromolecules, 18, 2023-2030, 1985):
η₀(340)=2.04×10⁻¹²×M_{w}^{2.94} (3)
which is transformed into formula (4) found below:
logM_{w}=[logη₀(340)−log (2.04×10⁻¹²)]/2.94 (4)
from which it is possible to obtain the M_{w} (weight average molecular weight).

Moreover, the M_{w} (weight average molecular weight) for fluorine-containing polymers other than FEP can be estimated in the same way by using the parameters from the above formula.

Thus, a melting point of 245-330° C. is preferable for the abovementioned fluorine-containing polymer. The melting point of the abovementioned fluorine-containing polymer is the temperature corresponding to the melting peak obtained by using a differential scanning calorimeter [DSC] while increasing the temperature at a rate of 10 degrees/minute.

At the same time, when the above fluorine-containing polymer is being utilized as a molding material, in the molding unit, it is preferable from this point of view for the fluorine-containing polymer to have melted below the melting temperature of the host polymer being used. It is preferable for this temperature to be at or below the processing temperature for the abovementioned host polymer, and it is more preferable for this temperature to be at or below the melting point for the abovementioned host polymer.

Next, specific compositions of the abovementioned fluorine-containing polymer will be described. In terms of the molecular structure, examples include perfluoropolymers such as poly(tetrafluoroethylene), TFE/HFP copolymer [FEP], and TFE/PAVE copolymer [PFA]. Here, the abovementioned perfluoropolymers are polymers obtained by a polymerization that uses a monomer composition including only the abovementioned perfluoromonomers. In other words, the abovementioned perfluoropolymers have repeating units that comprise only the abovementioned perfluoromonomers, including any derived structural units that are present such as an initiator at the terminus and chain transfer agents.

The abovementioned fluorine-containing polymer can optionally be obtained from polymerizations that include, in addition to the (co)monomers essential to the abovementioned copolymer, small amounts (5 mass % of the monomer composition or less, preferably 1 mass % of the monomer composition or less, more preferably 0.5 mass % of the monomer composition or less) of 1 or 2 or more comonomers comprising non-fluorine containing vinyl monomers such as ethylene [Et], and propylene [Pr] and the like; chlorofluorovinyl monomers such as chlorotrifluoroethylene [CTFE] and the like; other fluorovinyl monomers in addition to the abovementioned perfluoromonomers, such as vinylidene fluoride [VdF], vinyl fluoride, and trifluoroethylene and the like; monomers containing functional groups such as the hydroxyl group or carboxyl group and the like, and monomers having a cyclic structure. Without being limited to these examples in any particular way, the abovementioned cyclic structures can include cyclic ether structures such as cyclic acetals and the like, and preferably cyclic acetal structures that are constructed from not fewer that 2 carbon atom units, to become a part of the main chain of the abovementioned fluorine-containing polymer.

For such component monomers, the abovementioned fluorine-containing polymers, obtained from a copolymerization containing small amounts of comonomers other than the essential (co)monomers in the abovementioned copolymerization, include for example the FEP polymers obtained by copolymerizing with a small amount of a PAVE such as PPVE and the like.

The abovementioned small amount of a monomer for copolymerizing is preferably 5 mass % or less of the total of the abovementioned monomer composition, and is more preferably 1 mass % or less, and furthermore preferable is 0.5 mass % or less. If the amount exceeds 5 mass %, the intended properties of the copolymer will not be obtained.

One or 2 or more from among the abovementioned perfluoropolymers may be used as the abovementioned fluorine-containing polymer.

For the abovementioned fluorine-containing polymer, the abovementioned perfluoropolymers are preferable, and FEP and PFA are more preferable.

For the abovementioned fluorine-containing polymer, the main chain terminus and the side chains can optionally possess polar functional groups, and the presence of a few polar functional groups having reactivity toward the host polymer is preferable. Without being limited to these examples in any particular way, the abovementioned polar functional groups that have reactivity toward the host polymer can include —COF, —COOM, —SO₃M, —OSO₃M, and the like. Here M can stand for a hydrogen atom, a metal cation or a quaternary ammonium ion.

It is more preferable if the abovementioned fluorine-containing polymer substantially does not possess polar functional groups that have reactivity toward the abovementioned host polymer.

In the present specification, for substantially not possessing the abovementioned polar functional groups, even if the entire fluorine-containing polymer is seen to possess a few of the abovementioned polar functional groups on the main chain terminus and on the side chains, the degree of loss of function of the polar functional group can be considered to be the degree of nonparticipation in reactions with the abovementioned host polymer. For every 1,000,000 carbon atoms in the abovementioned fluorine-containing polymer, the number of the abovementioned polar functional groups possessed is preferably 50, and is more preferably 30, and is furthermore preferably 10.

As a result of the abovementioned fluorine-containing polymer substantially not possessing polar functional groups that possess reactivity toward the abovementioned host polymer, it will be possible to suppress reactions such as hydrolysis of the abovementioned host polymer during the preparation and mold processing of the polymer composition of matter of the present invention to be described hereinafter, so that it will be possible to exploit adequately the original properties of the abovementioned host polymer.

In addition, as a result of the abovementioned fluorine-containing polymer substantially not possessing polar functional groups, with the abovementioned fluorine-containing polymer, the friction will be reduced for the abovementioned host polymer, for example, within the mold of an extrusion molding unit or an injection molding unit, the die surface, nozzle, screw surface, the barrel inner wall, and the like. With the lubricant properties not being disrupted, the pressure and torque while molten will be diminished and it will be possible to reduce the fluctuations therein, so that it will be possible to increase the processability of the polymer composition of matter of the present invention.

The number of polar functional groups possessed by the abovementioned fluorine-containing polymer can be determined, for example, by using the methods described in U.S. Pat. No. 5,132,368. In other words, by using a film obtained by compression molding of the abovementioned fluorine-containing polymer in an infrared spectrophotometer, the absorbance is measured, and from a calibration factor (CF) determined from measurements of model compounds that contain the abovementioned polar functional groups, the number of end groups per 1,000,000 carbon atoms of the fluorine-containing polymer can be derived from the equation below.
Functional groups per 10⁶ carbon atoms=Absorbance×CF/Film thickness

Some examples of the wavelengths (μm) and calibration factors for the model compounds concerning the abovementioned polar functional groups include, respectively, 5.31 μm, 406 for —COF; 5.52 μm, 335 for —COOH; 5.57 μm, 368 for —COOCH₃.

The abovementioned fluorine-containing polymer can be synthesized by using the usual methods for polymerizing component monomers, which comprise polymerization methods such as emulsion polymerization, suspension polymerization, solution polymerization, bulk polymerization, vapor phase polymerization, and the like.

In the abovementioned polymerization reaction, chain transfer agents can also be used. Without being limiting in any particular way, while such examples of the abovementioned chain transfer agents as hydrocarbons such as isopentane, n-pentane, n-hexane, cyclohexane and the like; alcohols such as methanol and ethanol and the like; halogenated hydrocarbons such as carbon tetrachloride, chloroform, methylene chloride, methyl chloride and the like can be named, methanol is preferable.

In order for the abovementioned fluorine-containing polymer substantially not to possess the abovementioned polar functional groups, in addition to being able to use the abovementioned chain transfer agents suitably, in the case of emulsion polymerization, a polymer can possess the abovementioned polar functional group on a chain end at first, but after a steam treatment is carried out on the polymer, for example, and the chain end becomes stabilized, the abovementioned polar functional group will be lost. Treatment of the abovementioned polar functional group with, for example, fluorine gas (F₂) or ammonia, can convert it into a —CF₃ or —CONH₂, moreover, it can give a —CF₂H from the abovementioned steam treatment or hydrogen treatment. Accordingly, the abovementioned fluorine-containing polymer can optionally possess —CF₃, —CONH₂, or —CF₂H, or the like. The abovementioned —CF₃, —CONH₂, and —CF₂H and the like are different from the abovementioned polar functional groups. Furthermore, in the case of suspension polymerization, it is possible to obtain a polymer that substantially doesn't possess the abovementioned polar functional groups without having to carry out this sort of treatment.

In the present invention, the abovementioned fluorine-containing polymer preferably functions as a processing aid in the polymer composition of matter of the present invention. In other words, the abovementioned fluorine-containing polymer can function as a suitable processing aid to suppress increases in the extrusion pressure and extrusion torque during mixing and mold processing, in such a manner as to increase the mold processability. Accordingly, the polymer composition of matter of the present invention is of use in many applications, but particularly for use as a molding material, and can be used satisfactorily to produce a molded part by molding from a melt to be described hereinafter.

The thermoplastic polymer that forms a portion of the abovementioned fluorine-containing polymer in the polymer composition of matter of the present invention can be an amorphous non-fluorinated thermoplastic polymer or a crystalline non-fluorinated thermoplastic polymer with a melting point of 180° C. or higher.

In the present specification, the abovementioned “non-fluorinated thermoplastic polymer” is a thermoplastic polymer that substantially does not contain any C—F bonds.

For the abovementioned amorphous non-fluorinated thermoplastic polymer or crystalline non-fluorinated thermoplastic polymer with a melting point of 180° C. or higher, the polymers referred to as engineering plastics are preferable. The abovementioned engineering plastics generally possess excellent properties such as thermostability, high-strength, high dimensional stability, and the like.

In the present specification, the abovementioned engineering plastics are high performance plastics suitable for use in structural components or machinery components.

The abovementioned engineering plastics possess thermostability at 100° C. or higher, a tensile strength of 49 MPa (5 kgf—mm⁻²) or greater, and a flexural modulus of 2 GPa (200 kgf·mm⁻²) or greater. Not possessing these characteristics will render an engineering plastic unsuitable for use in the usual applications which require mechanical strength at high temperatures. A flexural modulus of 2.4 GPa (240 kgf·mm⁻²) or greater is preferred for use as the abovementioned engineering plastics.

Possessing the abovementioned thermostability at 100° C. or higher means that, respectively, the temperature for the melting point in the case of a crystalline resin, or the glass transition point in the case of an amorphous resin will not be less than 100° C., and that the mechanical strength does not deteriorate up to a temperature of 100° C. The deflection temperature under load (DTUL; ASTM D648) is generally used for measuring the abovementioned thermostability. The abovementioned deflection temperature under load is the temperature at which a test bar, prepared from the resin to be measured, begins to deform after being heated under a load of 1.82 MPa or 0.45 MPa. The abovementioned engineering plastics include those that generally possess a thermostability of 150° C. or higher, which are referred to as specialty engineering plastics or super engineering plastics.

The abovementioned tensile strength is the maximum stress needed to fracture the sample depending on the tensile load, and is the value of the maximum force divided by the original cross sectional area of the test bar. In the present specification, the abovementioned tensile strength is determined by using a method that is compliant with ASTM D638-00 (2000). With data for a reference composition of the raw resin without any stiffeners for the abovementioned engineering plastic, the abovementioned tensile strength will be 49-200 MPa.

The abovementioned flexural modulus is the load determined for a test bar in 3-point and 4-point bending tests—it is the modulus of elasticity calculated by using the deflection curve. In the present specification, the abovementioned flexural modulus is determined by using a method that is compliant with ASTM D790-00 (2000). With data for a reference composition of the raw resin without any stiffeners for the abovementioned engineering plastic, a value of 2-7 GPa is preferred for the abovementioned flexural modulus. The abovementioned flexural modulus more preferably has a lower limit of 2.4 GPa.

Without being limited to these examples in any particular way, the engineering plastics used as the abovementioned host polymer can be aliphatic polyamides [PA] such as nylon 6, nylon 11, nylon 12, nylon 46, nylon 66, nylon 610, nylon 612, nylon MXD6 and the like; aliphatic polyethers such as polyacetals [POM] and the like; polyethylene terephthalate [PET], polybutylene terephthalate [PBT], aromatic polyesters such as polyarylates and the like (including liquid crystal polyesters [LCP]); polycarbonates [PC]; modified polyphenylene ethers [PPE], aromatic polyethers such as polyether ether ketones [PEEK] and the like; polyamide imides [PAI] such as polyamino bis-maleimides and the like; polysulfones [PSU], polysulfone classes such as polyethersulfones [PES] and the like; polyphenylene sulfide [PPS], polyarylates [PAR], polyether imides [PEI], and polyimides [PI] and the like, but without being limited to that illustrated above, these examples may optionally be incorporated into the above-described conception of engineering plastics.

The abovementioned nylon MXD6 is the crystalline polycondensate obtained from metaxylylene diamine (MXD) and adipic acid.

The host polymer of the present invention, in addition to the abovementioned engineering plastics, may optionally be an amorphous non-fluorinated thermoplastic polymer or a crystalline non-fluorinated thermoplastic polymer with a melting point of 180° C. or higher, and more precisely, including acrylonitrile/butadiene/styrene copolymers [ABS], polystyrene [PS], poly(methylpentene), poly(methyl methacrylate) [PMMA], poly(vinyl chloride) [PVC], and the like.

One or 2 or more types can be used as the abovementioned host polymer.

The abovementioned host polymers, depending upon each type, can be synthesized by using heretofore known methods.

In the polymer composition of matter of the present invention, the abovementioned fluorine-containing polymer is present to the extent of 0.005-2 mass % of the total of the mass of the abovementioned host polymer and the mass of the abovementioned fluorine-containing polymer. If the mass percent of the abovementioned fluorine-containing polymer is less than 0.005%, the reduction of the pressure and torque during molding will be insufficient, and if the mass percent of the abovementioned fluorine-containing polymer exceeds 2%, in addition to the molded body obtained being opaque and cloudy, the intended effect of the increased amount of the abovementioned fluorine-containing polymer will not be achieved and the process will be uneconomical. For the abovementioned fluorine-containing polymer, a lower limit for the total of the mass of the abovementioned host polymer and the mass of the abovementioned fluorine-containing polymer is 0.01% is preferable, and a preferable upper limit is 1%, and a more preferred upper limit is 0.5%.

The combinations of the abovementioned fluorine-containing polymer and the abovementioned host polymer are not limiting in any particularly way, but with regard to the viscosity of both components during mold processing, the combination of FEP with nylon 66; the combination of FEP with nylon 46; and combinations with PTFE, FEP and/or PFA, and with PEEK are preferred. Among these, the combination of FEP with nylon 66; and, the combination of PTFE with PEEK are more preferred.

In the polymer composition of matter of the present invention, depending on the requirements, other components may optionally be combined together with the abovementioned fluorine-containing polymer and the abovementioned host polymer. Examples of the abovementioned other components that can be used, without being limiting in any particular way, are whiskers such as potassium titanate and the like, glass fibers, asbestos fibers, carbon fibers, and other high strength fibers, stiffeners such as powdered glass and the like; stabilizers such as minerals, flakes and the like; lubricants such as silicon oil, molybdenum disulfide and the like; colorants; electrical conductors such as carbon black and the like; agents to increase impact resistance such as rubber and the like; and other additives.

For the methods of producing the polymer composition of matter of the present invention, methods known heretofore can be used, and examples include the production method wherein the abovementioned fluorine-containing polymer and the abovementioned host polymer in the appropriate proportions are mixed to give the above-described mix ratio, and after heating depending upon the requirements, the mixture is then melted and kneaded.

The polymer composition of matter of the present invention used during the mold processing is obtained from the abovementioned fluorine-containing polymer and the abovementioned host polymer in an optionally selected mix ratio from within the above-described range. Accordingly, without being limiting in any particular way, examples of the abovementioned combination include the method of combining the abovementioned fluorine-containing polymer and the abovementioned host polymer in a mix ratio from within the abovementioned range from the beginning. Alternatively, if at first the percentage content of the abovementioned fluorine-containing polymer is somewhat higher than the abovementioned mix ratio range, then a stepwise combining method can be used so that after the composition of matter (1) is produced by adding and mixing the abovementioned fluorine-containing polymer and the abovementioned host polymer, together with the abovementioned additional components used depending on the requirements. In this way, the ratio of the abovementioned host polymer with respect to the abovementioned fluorine-containing polymer can be brought within the abovementioned range either before mold processing or during mold processing by adding more of the abovementioned host polymer to the composition of matter (1) to produce composition of matter (2).

In the latter stepwise combining method, the amount of the abovementioned fluorine-containing polymer will exceed 0.005 mass % of the total of the mass of the abovementioned host polymer and the mass of the abovementioned fluorine-containing polymer in the abovementioned composition of matter (1), which can be referred to as a “concentrate” or a “master batch”, and will preferably be 40 mass % or less, and more preferably will have a lower limit of 1 mass %, and furthermore preferably with have a lower limit of 2 mass %, and more preferably will have an upper limit of 20 mass %.

The abovementioned composition of matter (2) is referred to as the “premix”.

The abovementioned composition of matter (2) is obtained by adding more of the host polymer (B) to the above-described composition of matter (1) (the host polymer making up this composition of matter (1) is referred to below as “host polymer (A)”), and the fluorine-containing polymer will amount to 0.005-2 mass % of the total the abovementioned fluorine-containing polymer, the abovementioned host polymer (A) and the abovementioned host polymer (B).

The composition of matter of the present invention can be of any form whatsoever, such as powder, granules, pellets or the like.

Either of the abovementioned fluorine-containing polymer and the abovementioned host polymer can be of any form whatsoever, such as powder, granules, pellets or the like, but generally the abovementioned host polymer is often pellets and the abovementioned fluorine-containing polymer can be either as pellets or as a powder.

In order to increase the productivity and handleability of the abovementioned fluorine-containing polymers, they may optionally be made into mini-pellets. If the abovementioned host polymer is used in the form of pellets in the combination, it is possible for the host polymer pellets to have the same or substantially the same apparent weight by using the abovementioned fluorine-containing polymer in the form of mini-pellets in the combination. If the difference between the apparent weight of the host polymer and the apparent weight of the fluorine-containing polymer is large, this may produce the disadvantage that the mixture does not have a uniform mixed state to be fed in when carrying out the air feed to the extrusion molding unit, to the injection molding unit, or to the kneading unit, but if the fluorine-containing polymer is present as mini-pellets, it is anticipated that this disadvantage can be eliminated, which is preferred.

For example, when combining a polyamide 66 having a specific gravity of approximately 1.1 with a fluorine-containing polymer having a specific gravity of approximately 2.1, there is an approximately 2-fold difference in relative weight at the outset, and there will generally be a dilution factor of greater than approximately 200-fold, but with a smaller pellet width for the fluorine-containing polymer, from the relative surface area afforded by being made into mini-pellets, the drop time behavior of the host polymer and the fluorine-containing polymer during the air feed and in the hopper can be made more consistent.

For the polymer pellets subjected to melt processing, the size is decided on the basis of the gate cut of the screw inside the cylinder, and usually the cross-sectional width D is set to 1-2 mm and the length L is set to 2-4 mm.

For example, the average size of the pellets of polyamide 66 gives a pellet width of 1.5 mm and a pellet length of 3 mm, for a relative surface area of 30.5 cm²/g and a pellet mass of 0.0058 g.

For the dimensions of the fluorine-containing polymer pellets, in order for the relative surface area of the polyamide 66 pellets to match the relative surface area of the abovementioned fluorine-containing polymer, there is the method of approaching the cross-sectional width D with the smallest possible cylinder or sphere, or the method of using the largest thin dish shape for the cross-sectional width D. For the relationship between the pellet dimensions and the relative surface area and mass per pellet, in order to have a blending quantity for the fluorine-containing polymer of 0.5 mass % of the total of the fluorine-containing polymer plus the polyamide 66, the corresponding number of polyamide 66 (nylon) pellets (cross-sectional width 1.5 mm×length 3 mm) to add for diluting the fluorine-containing polymer pellets is shown in Table 1.

TABLE 1

| | Fluorine-containing | | | |
|---|---|---|---|---|
| | polymer pellets | | | Polyamide |
| | Cross- | | | 66 Pellets |
| Cylinder | sectional | Relative | | Number in |
| or | width D (mm) × | surface area | Mass of 1 | order to have |
| Sphere | length L (mm) | (cm²/g) | pellet (g) | 0.5 mass % (A) |
| ↑ | 0.8 × 0.5 | 42.9 | 0.0005 | 17.2 |
| | 0.6 × 1.0 | 41.5 | 0.0006 | 20.9 |
| | 0.8 × 1.0 | 33.2 | 0.0011 | 37.9 |
| | 0.8 × 1.5 | 30.2 | 0.0016 | 55.2 |
| | 1.0 × 1.0 | 27.7 | 0.0017 | 58.6 |
| ↓ | 2.0 × 0.5 | 28.6 | 0.0033 | 114 |
| dish | 3.0 × 0.5 | 25.5 | 0.0074 | 255 |

From Table 1 above, the cross-sectional width of the fluorine-containing polymer pellets is larger, and when the dish is matched up with the relative surface area of the polyamide 66, the number for the dilution by the latter is higher, so that the trend for producing a stabilizing effect of the fluorine-containing polymer is complicated. An example is the situation when there is not even one fluorine-containing polymer pellet present for several hundred nylon pellets during hopper drop and while the pellets are melting. At the same time, when the cross-sectional width of the fluorine-containing polymer is smaller, and the mini-pellets approximate the cylinders and spheres, the mass per fluorine-containing polymer pellet becomes smaller, and the number of nylon pellets for the dilution can become fewer.

The host polymer used in the polymer composition of matter of the present invention may produce some differences in the relative weight and the mass of the pellets, depending upon the type and upon whether any fillers are present, but most commonly, with a relative weight of 1.0-1.8, with a value for the relative weight of the fluorine-containing polymer of smaller than 1.7-2.3, it is preferable that the fluorine-containing polymer be made into mini-pellets.

The preferred dimensions of the abovementioned fluorine-containing polymer mini-pellets are a cross-sectional width D of 0.2-2.0 mm, and a length L of 0.2-2.0 mm. The more preferred lower limit for the cross-sectional width D of the abovementioned fluorine-containing polymer is 0.4 mm, the more preferred upper limit is 1.5 mm, the more preferred lower limit for the length L is 0.4 mm, and the more preferred upper limit is 1.5 mm.

When the abovementioned fluorine-containing polymer is made into mini-pellets, the form and dimensions may optionally be adjusted to correspond to the pellet feed method (particularly the air feed), the flowability inside the hopper, any adhesion due to electrostatic charge and the like, dilution factor, dispersion under conditions of low shear force (injection molding), and the like.

For the polymer composition of matter of the present invention from the combination of the abovementioned fluorine-containing polymer with the abovementioned host polymer, as described above, it is possible to increase the processability by decreasing the pressure and torque while molten, and it becomes plasticized easily. Accordingly, the polymer composition of matter of the present invention will have increased heat stability, with no deterioration in processability, the molding ability can be stabilized, and the surface qualities can be improved. In addition, it is remarkable that the effects of a low shrinkage ratio and low residual strain can be obtained with the polymer composition of matter of the present invention. For this reason, particularly in injection molding, molded products of uniform dimensions can be obtained with a shorter cooling time within the mold, so that molding cycle time can be shortened.

The method for producing a molded body of the present invention comprises the production of a molded body by molding a melt of the abovementioned polymer composition of matter.

The abovementioned method for producing a molded body comprises the introduction of the abovementioned polymer composition of matter into a molding unit such as a screw extrusion unit. Without being limiting in any particular way, examples of the hot melt process production method after introduction to the molding unit in this manner can be that the abovementioned polymer composition of matter is introduced into a molding unit such as a screw extrusion unit or the like. It is then heated to the molding temperature and is pressurized if required, then the melt of the abovementioned polymer composition of matter is extruded into the die of the molding unit and is molded while being injected into the mold, so that a method such as a heretofore known method can be used to obtain a molded product of the desired shape.

In the abovementioned method of producing a molded body, after the polymer composition of matter of the present invention melts to become a melt in the heating zone inside the molding unit, it is transferred from the abovementioned heating zone and into a cooling zone as it being molded. In this operation, for the polymer composition of matter of the present invention, it can be desirable to stabilize the transferability of the melt from the abovementioned heating zone inside the molding unit to the abovementioned cooling zone, which can increase the mold processability.

If the abovementioned fluorine-containing polymer in the polymer composition of matter of the present invention has a lower melting point than the abovementioned host polymer, it will melt before the abovementioned host polymer, and this can provide a more adequate lubricating action by the abovementioned fluorine-containing polymer inside the molding unit.

For the heating zone inside the abovementioned molding unit, for example, usually a melt extrusion unit in the case of an extrusion molding unit, this melt extrusion unit will generally possess a screw and a barrel, and the resin composition inside the abovementioned barrel is heated by a heater in the circumference of the abovementioned barrel.

For the abovementioned mold processability, for example in the case of an extrusion molding unit, it is possible to obtain a significant reduction in the extrusion torque and the extrusion pressure. In other words, in the case of an extrusion mold, depending on the composition of the abovementioned polymer composition of matter and the molding conditions, the extrusion torque can be reduced to up to 20-80% of the value when the abovementioned fluorine-containing polymer is not combined, and the extrusion pressure can be reduced to up to 40-90% of the value when the abovementioned fluorine-containing polymer is not combined.

Without limiting the abovementioned method for producing a molded body in any particular way, examples include extrusion molding, injection molding, compression molding, rotational molding, and the like. For the abovementioned method for producing a molded body, extrusion molding, injection molding, compression molding, rotational molding, and the like are preferable, and among these either extrusion molding or injection molding are preferable.

For the abovementioned extrusion mold, the method of molding is that the polymer composition of matter of the present invention is heated inside an extrusion unit and forms a melt and is continuously extruded from a die. For the abovementioned injection mold, the method of molding is that the polymer composition of matter of the present invention is heated inside an injection molding unit, and then a mold with one end closed is filled under pressure. In the present specification, for the abovementioned extrusion mold and the abovementioned injection mold, a parison previously created from the heated molten resin composition is inflated by using air pressure or the like inside the mold, and does not include the method of molding by adhering to the abovementioned mold that is blow molding.

Without being limiting in any particular way, for the conditions related to the abovementioned method of molding of a molded body in a molding unit, for example, can be those carried out as was heretofore known. Generally, a temperature at the melting point of the abovementioned host polymer or above is used as the molding temperature. The molding temperature can be within the abovementioned range, and generally will be a temperature less than the lower of the decomposition temperature for the abovementioned fluorine-containing polymer and the decomposition temperature for the abovementioned host polymer. For example, such a molding temperature can be 250-400 ° C.

Examples molded bodies that can be obtained by molding with the abovementioned method for producing a molded body, without being limiting in any particular way, are cladding material from extrusion molding; goods in the form of sheets, films, rods, piping, and tubing; and various shaped components from injection molding. A variety of forms can also be obtained from subjecting the shaped materials from extrusion molding to secondary processing such as cutting.

Without being limiting in any particular way, examples of applications for the abovementioned molded bodies would depend upon the type of host polymer used, but the ones most suitable for use would be dictated by beginning with the mechanical properties, chiefly the physical properties and thermoresistance. Examples of applications include various kinds of machinery and devices for use in equipment for use in space; machine components such as gears and cams; connectors, plugs, switches, electrical and electronic components such as enamels for use in electric wires; vehicles such as automobiles and aircraft or their component parts; laminates; electromagnetic tape, photographic film, various types of film such as gas permeation membranes; optical materials such as lenses; compact disks, optical disk substrates, and safety glasses, and the like; food utensils such as drinking vessels; various thermoresistant products for medical use; and various other kinds of manufactured articles and the like.

The polymer composition of matter of the present invention according to the above-described configuration allows for a reduction in the pressure and the torque during molding when the host polymer undergoes mold processing, and makes possible a shortening of the molding cycle time, and increases the mold processability.

These and other objects, features, aspects and advantages of the present invention will become apparent to those skilled in the art from the following detailed description, which discloses preferred embodiments of the present invention.

### DETAILED DESCRIPTION OF THE PREFERRED EMBODIMENTS

The embodiments shown below explain the invention in more specific terms, but the present invention is not limited to these embodiments.

### POLYMERIZATION EXAMPLE 1

(1) Production of an FEP Dispersion Liquid Containing FEP Seed Particles

A 3L-capacity horizontal stainless steel autoclave vessel equipped with stirring apparatus that was previously degassed was charged after degassing with 1.5 kg of distilled water and a 10 mass % aqueous solution of 282.7 g of a fluoro-type surfactant (C₇F₁₅COONH₄).

The apparatus was next charged with 124 g of tetrafluoroethylene [TFE]-hexafluoropropylene [HFP] liquid monomer mixture [TFE:HFP=25:75 (mass %)] with stirring while the temperature gradually rose, and at 95° C. the internal atmosphere of the autoclave had pressurized to 1.5 MPa. Next, the apparatus was charged with 13 g of an aqueous solution (10 mass %) of ammonium persulfate [APS] as a polymerization initiator, and the reaction commenced. A gaseous TFE-HFP monomer mixture (TFE:HFP=86:14 (mass %)) was supplied continuously to maintain an internal pressure of 1.5 MPa, and after 40 minutes the stirring was discontinued, and after blowing out the unreacted TFE and HFP monomer, 1.9 kg of a dispersion with a 6.8 mass % polymer solid content concentration. This dispersion is an FEP dispersion liquid containing FEP seed particles. A portion of the abovementioned FEP dispersion liquid was flocculated using nitric acid, and was precipitated to obtain a white powder. The FEP obtained had a composition by ¹⁹F-NMR of TFE:HFP=86.0:14.0 (mass %), and the melting point was 250° C., but it was not possible to measure the melt flow rate [MFR] at 372° C. under a 5 kgf load.

(2) Emulsion Polymerization

A 3 L autoclave that was previously degassed was charged after degassing with 1.6 kg of distilled water, and further charged with 18.9 g of the FEP dispersion liquid containing FEP seed particles from the preparation in (1). The apparatus was then charged with 61 9 g of a liquid TFE-HFP monomer mixture (TFE:HFP=25:75 (mass %)) with stirring while the temperature rose gradually, until at 95° C. the internal atmosphere of the autoclave had pressurized to 4.2 MPa. Next, the apparatus was charged with 45.3 g of a 10 mass % aqueous APS solution, and the reaction commenced. From the time that the reaction commenced, a gaseous TFE-HFP monomer mixture (TFE:HFP=86:14 (mass %)) was supplied continuously to maintain an internal pressure of 4.2 MPa. The polymerization was continued until the polymer solid content concentration had reached approximately 15 mass %. The reaction time period was 40 minutes. After this, the stirring was discontinued, and after the unreacted TFE and HFP monomer was blown out, the dispersion was withdrawn, and after flocculation using nitric acid followed by precipitation, a white powder was obtained. After drying, the mass of the FEP was 270 g. The copolymer composition obtained had a ratio of TFE:HFP=86.8:13.2 (mass %), and a melting point of 256° C., but it was not possible to measure the MFR at 372° C. under a 5 kgf load.

### POLYMERIZATION EXAMPLE 2

The FEP dispersion liquid containing FEP seed particles obtained in polymerization example 1 (1) was used, and with the exception that the amount of the 10 mass % aqueous APS solution charged was changed to 17.9 g, the polymerization was carried out in the same manner as for embodiment 1. After drying, the mass of the FEP was 350 g. The FEP composition obtained had a ratio of TFE:HFP=88.9:11.1 (mass %), a melting point of 256° C., and the MFR at 372° C. under a 5 kgf load was 281 g/10 minutes.

### POLYMERIZATION EXAMPLE 3

A 4L-capacity glass-lined autoclave equipped with a stirring apparatus was charged after degassing with 1.3 kg of purified water, and after substitution with nitrogen the system was brought under a vacuum, and was charged with 1 334 g of liquid HFP monomer with stirring while maintaining the temperature of the polymerization vessel at 25° C., and the pressure of internal atmosphere of the autoclave rose to 0.65 MPa. Next, TFE was added until the apparatus was pressurized to 0.86 MPa, and 10 g of methanol was added as a chain transfer agent.

Then, the apparatus was charged with 26.8 g of di-(ω-hydrodecafluoroheptanoyl)peroxide [DHP], diluted to approximately 8 mass % in perfluorohexane, to initiate the reaction. During the reaction, an additional 311 g of TFE was charged, and the pressure inside the autoclave was kept at 0.86 MPa. Moreover, another 26.8 g of TFE was added every 30 minutes after the reaction had commenced.

After the reaction had been carried out for a total of 6 hours, the unreacted TFE and HFP was discharged, and a granular powder was obtained. Purified water was added to this granular powder, and after stirring, the contents were withdrawn from the autoclave. After drying for 48 hours at 150° C., 353 g of low molecular weight FEP was obtained as a powder.

The low molecular weight FEP composition obtained had a ratio of TFE:HFP=86.1:13.9 (mass %), and a melting point of 257° C., but it was not possible to measure the MFR at 372° C. under a 5 kgf load.

### POLYMERIZATION EXAMPLE 4

With the exception that the chain transfer agent was not added, this polymerization was carried out in the same manner as for Polymerization Example 3.

After drying for 48 hours at 150° C., 348 g of low molecular weight FEP was obtained as a powder. The low molecular weight FEP composition obtained had a ratio of TFE:HFP=87.8:12.2 (mass %), and a melting point of 259° C., but it was not possible to measure the MFR at 372° C. under a 5 kgf load.

### POLYMERIZATION EXAMPLE 5

With the exception that a chain transfer agent was not added, additional TFE was not charged, and the polymerization time period was 3 hours, this polymerization was carried out in the same manner as for polymerization example 3. After drying for 48 hours at 150° C., 262 g of low molecular weight FEP was obtained as a powder. The low molecular weight FEP composition obtained had a ratio of TFE:HFP=87.2:12.8 (mass %), a melting point of 252° C., and an MFR at 372° C. under a 5 kgf load of 262 g/10 minutes.

Viscosity Measurements

The melt viscosity measurements were carried out under the conditions mentioned below, and the zero shear viscosity at 360° C. was calculated on the basis of the above-described conversion formula obtained from the known viscosity measurement values for FEP at 285° C. and 340° C. The conditions for the melt viscosity measurements are given below.

Measurement instrument: Physica brand MCR500 Modular Compact Rheometer

Measurement method: parallel plate ø25

Sample thickness: 1.5 mm; 1.0 mm for lower viscosity samples

Measurement temperature: 285° C.

Measurement frequency: 2-100 rad/second

Conversion from zero shear viscosity to weight average molecular weight

The weight average molecular weight [M_{w}] is calculated using the above-described correlation equation for the M_{w} and the zero shear viscosity (η₀) at 340° C. The results are shown in Table 2. Furthermore, in Table 2, FEP-1, FEP-2, and FEP-3 are 3 generic types of FEP. In other words, the weight average molecular weight [M_{w}] for generic FEP is 300,000-1,000,000.

TABLE 2

| | Melting | Zero shear | Zero shear | |
|---|---|---|---|---|
| | point | viscosity at | viscosity at | |
| | (° C.) | 285° C. (Pa · s) | 340° C. (Pa · s) | M_{w} |
| Polymerization | 250 | 122 | 86 | 90,000 |
| Example 1 | | | | |
| Polymerization | 256 | 844 | 591 | 180,000 |
| Example 2 | | | | |
| Polymerization | 257 | 38 | 27 | 60,000 |
| Example 3 | | | | |
| Polymerization | 259 | 448 | 314 | 150,000 |
| Example 4 | | | | |
| Polymerization | 252 | 1,517 | 1,063 | 220,000 |
| Example 5 | | | | |
| Reference | — | — | 6700 | 410000 |
| Example 1 | | | | |
| (FEP-1) | | | | |
| Reference | — | — | 16000 | 550000 |
| Example 2 | | | | |
| (FEP-2) | | | | |
| Reference | — | — | 46000 | 790000 |
| Example 3 | | | | |
| (FEP-3) | | | | |

It can be seen from Table 2 that the FEP polymers obtained from polymerization examples 1-5 have a lower weight average molecular weight as compared to the generic FEP polymers.

### Embodiment 1 Evaluation of Mold Processability from a Mixer Experiment

A 57.6 g sample of polycarbonate resin pellets (trade name: Panlite L-1225, Teijin Kasei Co.) was charged to a Brabender® Mixer set to 10 rpm at 270° C. over a period of approximately 1 minute. Next, 0.228 g of the low molecular weight FEP powder obtained in polymerization example 2 (with a mass ratio of 0.5 mass %) was charged over a period of 20 seconds, and this was mixed for 2 minutes after the beginning of the experiment. When 2 minutes had elapsed, the rotation speed of the Brabendere Mixer was changed to 30 rpm, and the contents were mixed until 15 minutes had elapsed. Over the time between when the test specimen was charged and when it melted, the mixer torque displayed a high value until 2 minutes had elapsed, and then stabilized at a lower level when the sample had entirely melted. When 2 minutes had elapsed and the rotation speed was increased to 30 rpm, a one-time increase to a maximal value (peak torque value) was shown, but afterwards it gradually decreased, and by 4 minutes after the beginning of the experiment it showed stabilization to a uniform torque value. The average torque value during mixing was calculated from measurements at 5, 7, 9, 11, 13, and 15 minutes after stabilization. Furthermore, the decrease in power consumption due to the decreased torque during mixing was evaluated for evaluating the mold processability.

The energy consumption after the maximum value, the peak torque value and the average torque value are shown in Table 3.

### Embodiment 2

With the exception that the low molecular weight FEP used was changed to the polymer obtained from polymerization example 3, this experiment was carried out in the same manner as for Embodiment 1. The energy consumption after the maximum value, the peak torque value and the average torque value are shown in Table 3.

### COMPARATIVE EXAMPLE 1

With the exception that the mixing was carried out after charging only the polycarbonate resin, this experiment was carried out in the same manner as for Embodiment 1. The energy consumption after the maximum value, the peak torque value and the average torque value are shown in Table 3.

### COMPARATIVE EXAMPLE 2

With the exception that the FEP polymer used was from the second member of the series of the heretofore known generic polymer samples with a molecular weight of approximately 500,000, this experiment was carried out in the same manner as for Embodiment 1. The energy consumption after the maximum value, the peak torque value and the average torque value are shown in Table 3.

### COMPARATIVE EXAMPEL 3

With the exception that the FEP polymer used was changed to the heretofore known perfluoro(propyl vinyl ether) [PPVE], with a molecular weight of approximately 500,000, this experiment was carried out in the same manner as for Embodiment 1. The energy consumption after the maximum value, the peak torque value and the average torque value are shown in Table 3.

TABLE 3

| | Energy | | |
|---|---|---|---|
| | consumption | | Average |
| | after peak value | Peak torque | torque |
| | [MJ/m³] | [N · m] | [N · m] |
| Embodiment 1 | 562 | 16.7 | 7.6 |
| Embodiment 2 | 540 | 12.1 | 7.7 |
| Comparative | 640 | 21.5 | 8.6 |
| Example 1 | | | |
| Comparative | 595 | 18.8 | 8.0 |
| Example 2 | | | |
| Comparative | 610 | 18.2 | 8.2 |
| Example 3 | | | |

It can bee seen from Table 3 that, for any among the energy consumption after the maximum value, the peak torque, and the average torque, the smaller the molecular weight used, the more significant the decrease in the value.

### Embodiment 3 Evaluation of Mold Processability from an Injection Molding Experiment

Using an injection molding unit (trade name: SG50M IV, Sumitomo Heavy Industries, Ltd.), 1900 g of polyamide 66 resin (trade name: Leona 1300, Asahi Kasei Industries) was weighed into a polyethylene bag, and 10 g of the low molecular weight FEP powder obtained from polymerization example 5 was weighed and added to the same polyethylene bag. These pellets and powder were tumbled together so that the surface of the polyamide 66 pellets was covered with the FEP powder, and this was charged to the hopper.

The conditions for the molding are given below.

Cylinder temperature: 240-275° C.

Nozzle temperature: 270° C.

Molding temperature: 80° C.

Mold type: Bar mold (127 mm×12.7 mm×3.2 mm, Daikin Industries)

Molding cycle time: 77 seconds

Cooling time: 40 seconds

After the molding had begun, the initial 5 shots were discarded, and the 6^{th} through 15^{th} shot were taken as samples for measurement.

The results for the shrinkage measurements for these samples are shown in Table 4. Furthermore, the shrinkage was calculated based on the ASTM D 955 compliant formula below:
Shrinkage (mm/mm)=(L₁−L₂)/L₁

(L₁: mold dimension; L₂: molded product dimension)

### Embodiment 4

With the exception of a cooling time of 35 seconds in the molding conditions, this experiment was carried out in the same manner as for Embodiment 3.

The results for the shrinkage measurements for these samples are shown in Table 4.

### COMPARATIVE EXAMPLE 4

With the exception of molding only with polyamide 66 resin, this experiment was carried out in the same manner as for Embodiment 3.

The results for the shrinkage measurements for these samples are shown in Table 4.

### COMPARATIVE EXAMPLE 5

With the exception that the tetrafluoroethylene/hexafluoropropylene copolymer [FEP] used was from the second member of the series of the heretofore known samples with a molecular weight of approximately 500,000, this experiment was carried out in the same manner as for Embodiment 3. The results for the shrinkage measurements for these samples are shown in Table 4.

TABLE 4

| | Shrinkage (mm/mm) |
|---|---|
| Embodiment 3 | 0.0064 |
| Embodiment 4 | 0.0065 |
| Comparative Example 4 | 0.0072 |
| Comparative Example 5 | 0.0067 |

From Table 4, the embodiment examples have better flowability than the Comparative Examples and the shrinkage was less.

The polymer composition of matter of the present invention has high processability, the pressure and torque during molding is lower, the extrusion rate is increased, the molding cycle can be shortened, the productivity of the melt molding is increased, and the production costs can be diminished.

What is claimed is:

1. A polymeric composition of matter comprising a thermoplastic polymer and a fluorine-containing polymer, wherein
said thermoplastic polymer is an amorphous non-fluorinated thermoplastic polymer or a crystalline non-fluorinated thermoplastic polymer with a melting point of 180° C. or higher;
said fluorine-containing polymer has a zero shear viscosity at 340° C. of 0.2 Pa.s or greater and less than 5000 Pa.s; and
said fluorine-containing polymer is present to the extent of 0.005-2 mass % of the total of said thermoplastic polymer and said fluorine-containing polymer.

2. The polymeric composition of matter recited in claim 1, wherein the melting point of the fluorine-containing polymer is 245-330° C.

3. The polymeric composition of matter recited in claim 1, wherein the fluorine-containing polymer is a tetrafluoroethylene/hexafluoropropylene copolymer.

4. A method of molding, comprising the step of producing a molded body from a melt of the polymeric composition of matter recited in claim 1.
